(19) United States
(12) Patent Application Publication
(10) Pub. No.: US 2002/0121848 A1
(43) Pub. Date: Sep. 5, 2002

(54) Backlight module for electro-optical display

(76) Inventors: Chih-Kung Lee, Taipei (TW); Yuan-Fuu Huang, Taipei (TW); Shu-Sheng Lee, Taipei (TW); Ching-Heng Tang, Taipei (TW)

Correspondence Address: BAKER & McKENZIE, 12th Floor, 101 West Broadway, San Diego, CA, 92101, US

(21) Appl. No.: 09/949,463

(22) Filed: Sep. 7, 2001

(30) Foreign Application Priority Data
Oct. 5, 2000 (TW) 89120785

(51) Int. Cl. H01J 5/16

(52) U.S. Cl. 313/112

(57) ABSTRACT

An electro-optical display backlight module for generating a light source of a single polarization state, which reduces the optical loss in light beam output, is suitable for mass production, and decreases manufacturing costs, is disclosed. The backlight module is easily integrated with conventional electro-optical display devices and achieves high-quality polarization splitting through suitable designs. The backlight module of the present invention comprises an under plate having a ridged lower surface and an upper surface; a phase retardation film of high reflectivity disposed on the lower surface of the under plate; a double-sided electroluminescent panel having a lower surface, substantially complementary to the upper surface and facing therewith, and an upper surface; a substrate having a lower surface, substantially complementary to the upper surface of the double-sided electroluminescent panel and facing therewith, and an upper surface; and a polarization splitting film disposed on the upper surface of the substrate, providing transmission of predetermined polarization state and reflection of predetermined polarization state of the light source.

### BACKGROUND OF THE INVENTION

1. Field of the Invention

This invention relates generally to a backlight module of an electro-optical display device, and more particularly to a backlight module for generating a light source of a single polarization state.

2. Description of the Prior Art

With the advent of the information technology (IT) age, there is an increasing demand for high-quality liquid crystal displays (LCDs). Higher quality imaging requires the more efficient utilization of light sources. Conventionally, for obtaining singly-polarized light beam output from a LCD backlight module, a polarization plate is arranged near the light source to inhibit the passage of certain polarized light beams, whereby the polarized light beams which are not parallel are prevented from being transmitted. In practice, the resultant light beams of a single polarization state are less than half of those of the original light source in terms of illuminance.

FIG. 1 illustrates a conventional liquid crystal display having a conventional single-sided electroluminescent panel (the conventional backlight module) 29 comprising a reflective film 291, an insulating layer 292, an illuminating layer 293 and a transparent electrode 294. The illuminating layer 293 is a light source emitting light beams at its upper and lower surfaces. The light beams emitted from the upper surface of the illuminating layer 293 will pass through the upper transparent electrode 294, whereas the light beams emitted from the lower surface of the illuminating layer 293 will transmit through the insulating layer 292 and thereafter be reflected by the reflective layer 291 so as to pass through the insulting layer 292 and illuminating layer 293 in sequence and finally pass through the transparent electrodes 294. When a non-polarized light beam is emitted from single-sided electroluminescent panel 29, it loses approximately 50% of its optical strength due to the screening effect in terms of polarization states by the polarization plate 14. Moreover, reflective film 291 may cause further optical loss due to light absorption. In addition, the power consumption of the conventional backlight module is significant even as the display quality is adversely affected. Large scale liquid crystal displays utilizing such conventional backlight modules are also difficult to produce, particularly in large quantities. Conventional single-sided electroluminescent panels used for a backlight module of, for example, a cell phone, typically are utilized only in STN-LCDs (supertwist nematic LCD), rather than in the more technologically advanced TFT-LCDs (thin film transistor LCD).

### SUMMARY OF THE INVENTION

In view of the above problems, the principal object of the present invention is to provide a backlight module for generating a light source of a single polarization state, which reduces the optical loss in light beam output, is suitable for mass production, and decreases manufacturing costs.

Another object of the present invention is to provide a backlight module for generating a light source of a single polarization state, which is easily integrated with conventional electro-optical display devices and achieves high-quality polarization splitting.

To achieve these objects, the present invention provides a backlight module for generating a light source of single polarization state, comprising

an under plate having a ridged lower surface and an upper surface;

a phase retardation film of high reflectivity, disposed on the ridged lower surface of the under plate;

a double-sided electroluminescent panel having a lower surface, substantially complementary to the upper surface of the under plate and facing therewith, and an upper surface;

a substrate having a lower surface, substantially complementary to the upper surface of the double-sided electroluminescent panel and facing therewith, an upper surface and four side-surfaces; and

a polarization splitting film disposed on the upper surface of the substrate, providing transmission of predetermined polarization state and reflection of predetermined polarization state of the light source.

For avoidance of the optical loss from the side-surfaces of the substrate, reflective films of high reflectivity may be provided on four side-surfaces of the substrate so as to confine the light beams therein. It should be noted that the substrate could be omitted so as to simplify the construction of the backlight module. In order to enhance optical performance, the ridge pitch of each of the ridged surfaces may be constant or not, and the ridge lines thereof are preferred not to be parallel to the polarizing direction of the light beam reflected by the polarization splitting film, thus allowing greater freedom of backlight module design. Further, an undulated film with, for example, cylindrical, spherical or non-spherical undulations can be disposed on the polarization splitting film for controlling the output angle and diffusion angle of the light beams.

The present invention further provide a backlight module for generating a light source of single polarization state, comprising

a double-sided electroluminescent panel having a lower surface and an upper surface;

a scattering structure having an upper surface, substantially complementary to the lower surface of the double-sided electroluminescent panel and facing therewith, and a lower surface;

a reflective film of high reflectivity disposed on the lower surface of the scattering structure; and

a polarization splitting film disposed on the upper surface of the double-sided electroluminescent panel, providing transmission of predetermined polarization state and reflection of predetermined polarization state of the light source.

In addition, the concept for increasing the efficiency of light beams output from a backlight module according to the present invention may be utilized with a single-sided electroluminescent panel, wherein the backlight module comprises

a single-sided electroluminescent panel having an upper surface and a lower surface, comprising an illuminating layer, an insulating layer, a transparent electrode and a reflective layer;

a scattering structure having a lower surface, substantially complementary to an upper surface of the single-sided electroluminescent panel and facing therewith, and an upper surface; and

a polarization splitting film disposed on the upper surface of the scattering structure, providing transmission of predetermined polarization state and reflection of predetermined polarization state of the light source.

To simplify such a construction, the scattering structure may be omitted if the insulating layer of the single-sided electroluminescent panel effects scattering for conversion of the polarization states of the light beams.

Additional advantages, objects and features of the present invention will become more apparent from the drawings and description which follows.

### BRIEF DESCRIPTION OF DRAWINGS

The present invention will become more apparent from the detailed description given hereinbelow when read in conjunction with the accompanying drawings, which are given by means of illustration only and thus are not limitative of the present invention, in which:

FIG. 1 is a schematic drawing showing a conventional backlight module comprising a single-sided electroluminescent panel for a liquid crystal display;

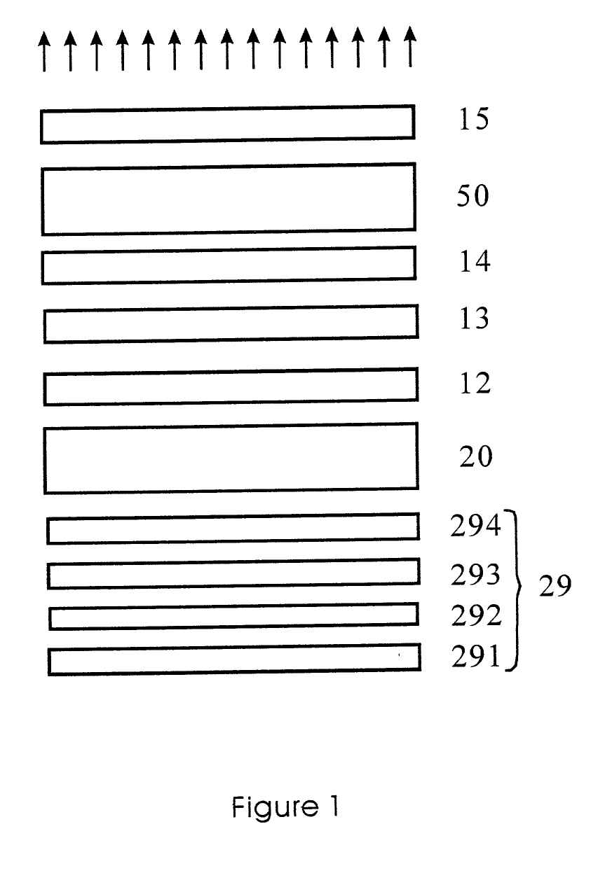

FIG. 2 is a schematic drawing showing a double-sided electroluminescent panel according to the present invention;

FIG. 3 is a sectional view showing a backlight module comprising a double-sided electroluminescent panel according to one embodiment of the present invention;

FIG. 4 is a schematic drawing showing a two-layer stake of films forming a single interface according to U.S. Pat. No. 5,962,114;

FIG. 5 is a schematic drawing, showing the reflection and transmission effect regarding light beams of two different polarization states according to U.S. Pat. No. 5,962,114;

FIG. 6 is a schematic drawing showing the optical path in the backlight module according to the present invention;

FIG. 7 is a perspective view showing the backlight module according to the present invention;

FIG. 8 shows the relationship between the relative phase difference of P-S polarized components over different wavelengths of light beams reflected by a typical phase retardation film of high reflectivity;

FIG. 9 shows the relationship between the reflectivity of P-S polarized components over different wavelengths of light beams reflected by a typical phase retardation film of high reflectivity.

FIG. 10 is a perspective view of the backlight module according to the present invention, in which a film having cylindrical undulations thereon is disposed on the polarization splitting film;

FIG. 11 is a perspective view of the backlight module according to the present invention, in which a film having square protuberances thereon is disposed on the polarization splitting film;

FIG. 12 is a sectional view of the backlight module according to another embodiment of the present invention, comprising a scattering structure;

FIG. 13 is a sectional view of the backlight module utilizing a single-sided electroluminescent panel according to another embodiment of the present invention, wherein a scattering structure is included therein; and

FIG. 14 is a sectional view of the backlight module utilizing a single-sided electroluminescent panel according to another embodiment of the present invention, wherein the insulating layer of the single-sided electroluminescent panel has scattering effect.

### DETAILED DESCRIPTION OF THE INVENTION

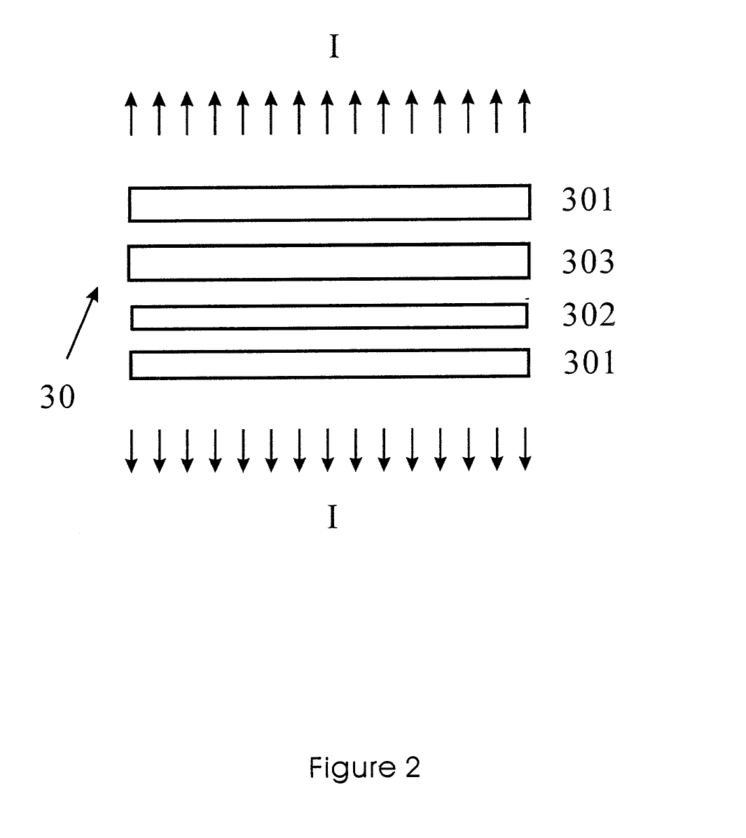

With reference to FIG. 2, a double-sided electroluminescent panel 30 according to the present invention is shown. The double-sided electroluminescent panel 30 comprises two transparent electrodes 301, one insulating layer 302 and one illuminating layer 303. The illuminating layer 303 is a light source emitting light beams at its upper and lower surfaces. The light beams emitted from the upper surface of the illuminating layer 303 will pass through the upper transparent electrode 301, whereas the light beams emitted from the lower surface of the illuminating layer 303 will transmit through the insulating layer 302 and thereafter pass through the lower transparent electrode 301. The light beams out of the double-sided illuminator 30 are generally designated as I. Since a reflective layer 291 used in a conventional single-sided electroluminescent panel is omitted, the resultant illuminance according to the present invention can be greatly enhanced.

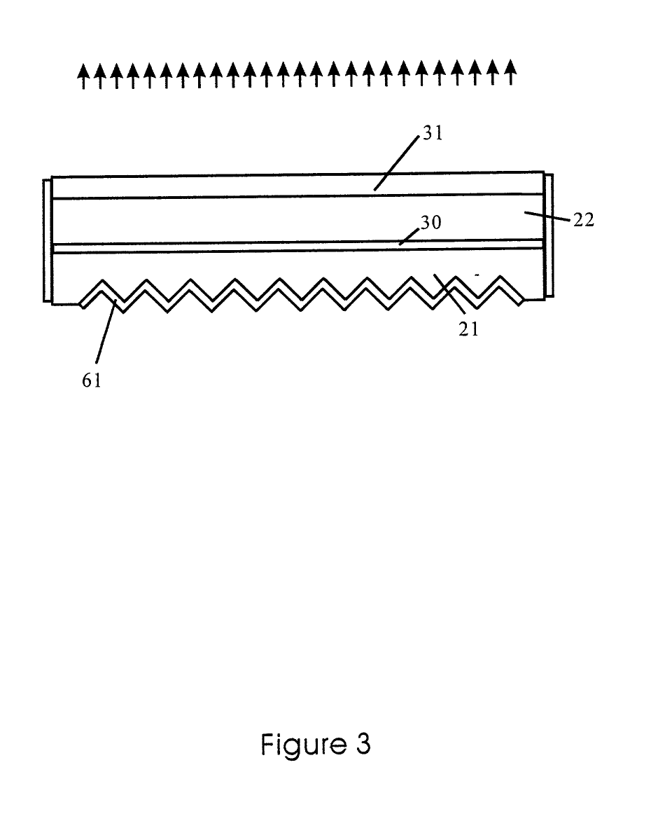

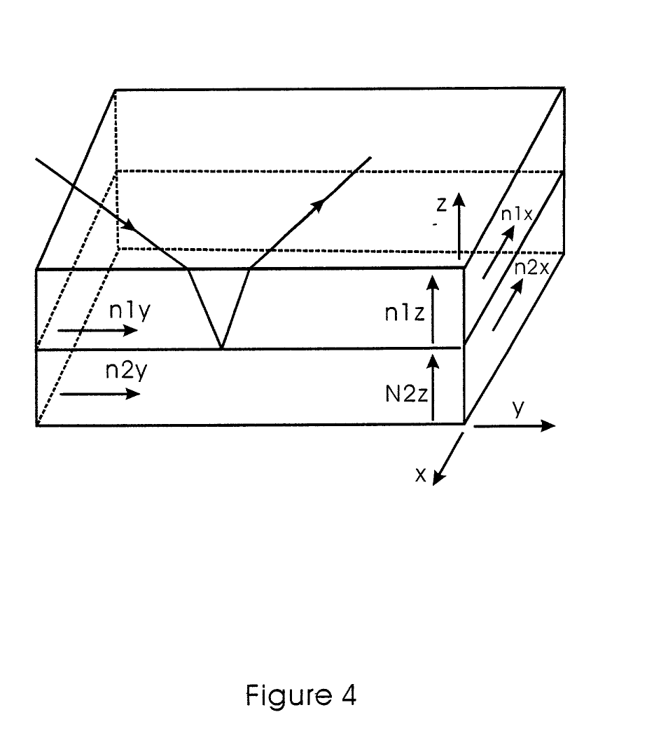

With reference to FIG. 3, a section view of a backlight module according to one embodiment of the present invention is shown. The backlight module is a laminate configuration comprising an under plate 21, a double-sided electroluminescent panel 30, a substrate 22 and a polarization splitting film 31. The under plate 21 has a ridged lower surface and a phase retardation film 61 is disposed thereon, which functions to convert the light beams incident thereto in terms of polarization states and reflect the converted light beams to the polarization splitting film 31. In this embodiment, the ridge angle between any two neighboring ridges on the ridged lower surface of the under plate 21 is 90 degrees. However, any ridge angle suitable for reflection of the light beams thereto can be utilized. The polarization splitting film 31 is a film that permits light beams of specific polarization state to be transmitted through and others to be reflected. For example, the multilayer film disclosed in U.S. Pat. No. 5,962,114, which is incorporated herein for reference, can be utilized as a polarization splitting film according to the present invention. FIG. 4 shows a two-layer stake of films forming a single interface according to U.S. Pat. No. 5,962,114, in which two films are laminated along the z-direction. The refractivity of the films along the x-, y- and z-direction are (n1x,n1y,n1z) [symbol] (n2x,n2y,n2z) respectively. According to the teaching from U.S. Pat. No. 5,962,114, if (n1y-n2y) and (n1z-n2z) are of the same sign, the polarized light beam along the x-direction will be transmitted through the films and the polarized light beam along the y-direction will be reflected. Therefore, light beams of different polarization states can be splitted.

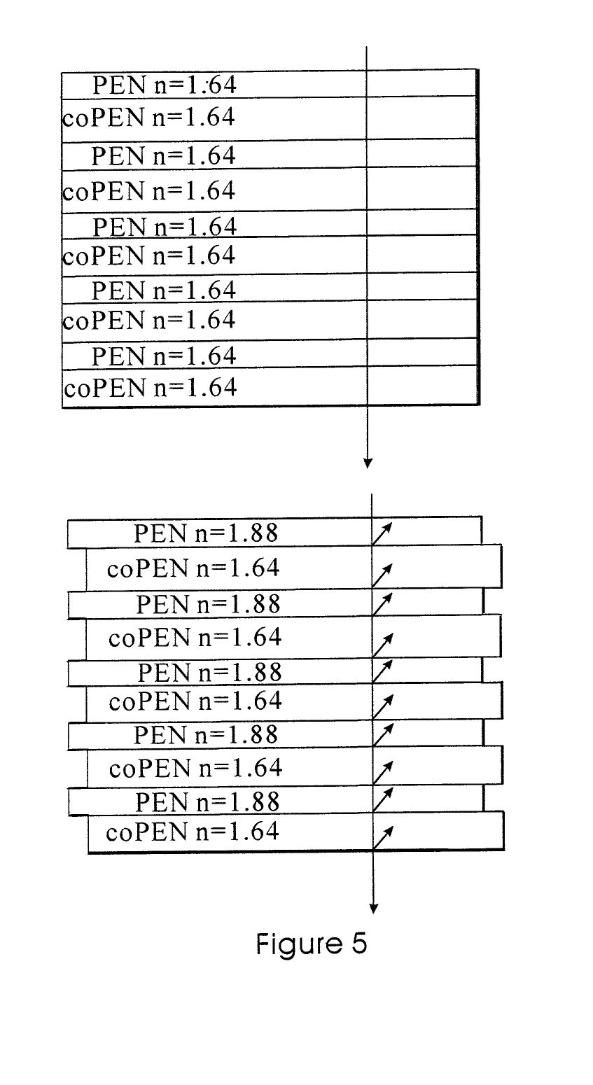

FIG. 5 shows the reflection and transmission effect regarding light beams of two different polarization states according to the multilayer film of U.S. Pat. No. 5,962,114, which can be utilized in the present invention. The multilayer film shown in FIG. 5 is composed of PEN (2,6-polyethylene naphthalate) and coPEN (copolymer derived from ethyleneglycol, naphthalene dicarboxylic acid and some other acids such as terephthalate) and allows polarized light beams in specific direction to be transmitted and others in the direction perpendicular to the specific direction to be reflected.

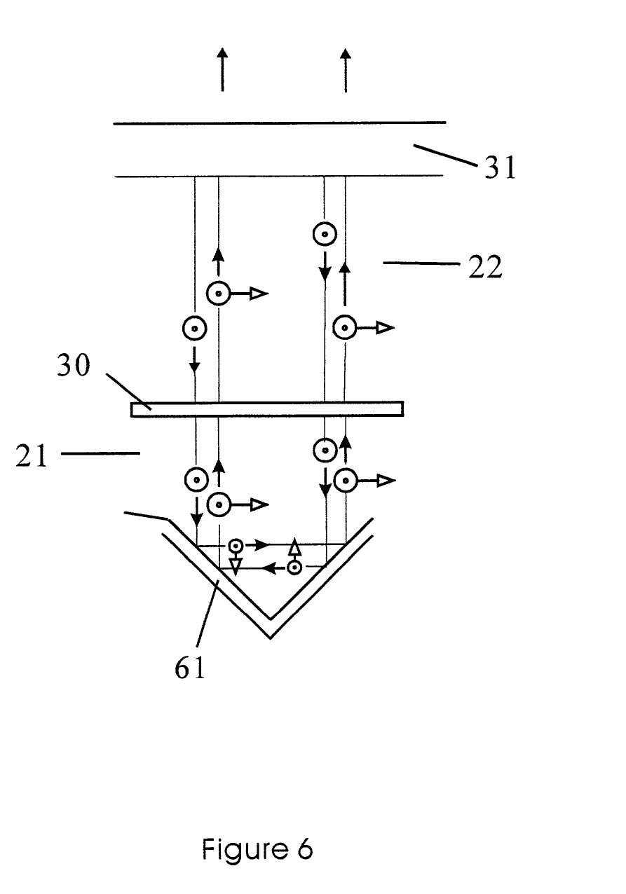

With reference to FIG. 6, an optical path, regarding light beams generated from the double-sided electroluminescent panel 30, between the under plate 21 and the polarization splitting film 31 is shown, wherein the solid arrow designates the direction which the light beams propagates, the hollow arrow designates the P-polarized component, and the circle with a black dot in designates the S-polarized component. It should be noted that the P-polarized component means the component which may pass through the polarization splitter film, whereas the S-polarized component is perpendicular to the P-polarized one and will be reflected back by the polarization splitter film. In this case, non-polarized light beams I travel upward to the polarization splitting film 31, with the P-polarized components directly passing through the polarization splitting film 31 and the S-polarized components reflected by the polarization splitting film 31. After the S-polarized components reflected by the polarization splitting film 31 and non-polarized light beams generated by the double-sided electroluminescent panel 30 travelling downward are continuously reflected at the ridged lower surfaces of the under plate 21, they will be converted by the phase retardation film 61 to possess P- and S-polarized components partially. Similarly, the P-polarized components will pass through the polarization splitting film 31, whereas the S-polarized components will be reflected and then be reflected and converted by the phase retardation film 61 again. Through a series of the above procedures, the non-polarized light beams are output as P-polarized light beams of a single polarization state. It is noted that in FIG. 6, the ridge pitch of the ridged lower surfaces of the under plate is a predetermined constant value.

It should be noted that while the direction of the S-polarized components reflected by the polarization splitting film is not parallel to that of the ridge lines on the ridged lower surface of the under plate, any conventional reflection film may be advantageously utilized to achieve the effect by the phase retardation film disclosed in the present invention. Alternatively, while the direction of the S-polarized components is parallel to that of the ridge lines, the phase retardation effect and thereby the conversion of the polarization states cannot be achieved by the phase retardation film unless certain magnetic materials are adding therein. The phase retardation film may be a dry film formed by an optical-precision application process or be coated through evaporation onto the ridged lower surface of the under plate. In this embodiment, the ridge angle between any two neighboring ridges of the under plate is 90 degrees, so that continuous reflection or total reflection of the light beams can be achieved at the ridged lower surface of the under plate 21.

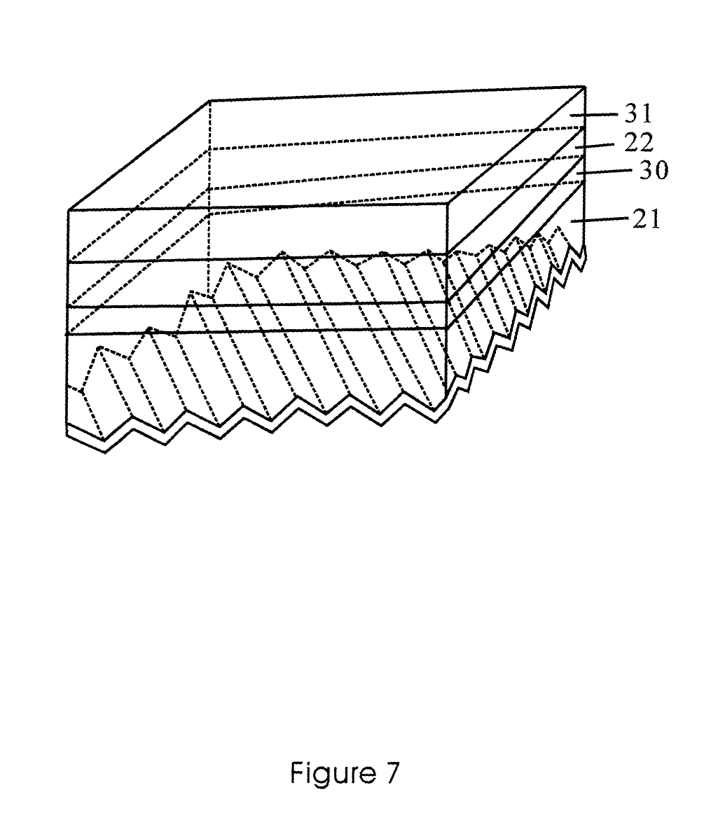

With reference to FIG. 7, another embodiment of backlight module in accordance with the present invention is disclosed. The ridge pitch of the ridges on the ridged lower surface of the under plate is variable, and the direction of the S-polarized components reflected by the polarization splitting film is not parallel to that of the ridge lines, so as to increase the freedom in designing the phase retardation film. It should be noted that any conventional reflection film may be advantageously utilized to achieve the effect by the phase retardation film disclosed in the present invention in this embodiment since the direction of the S-polarized components of the light beams reflected by the polarization splitting film is not parallel to that of the ridge lines.

For clarifying the features of the present invention, the configuration and inventive principles of the present invention is in detail described below.

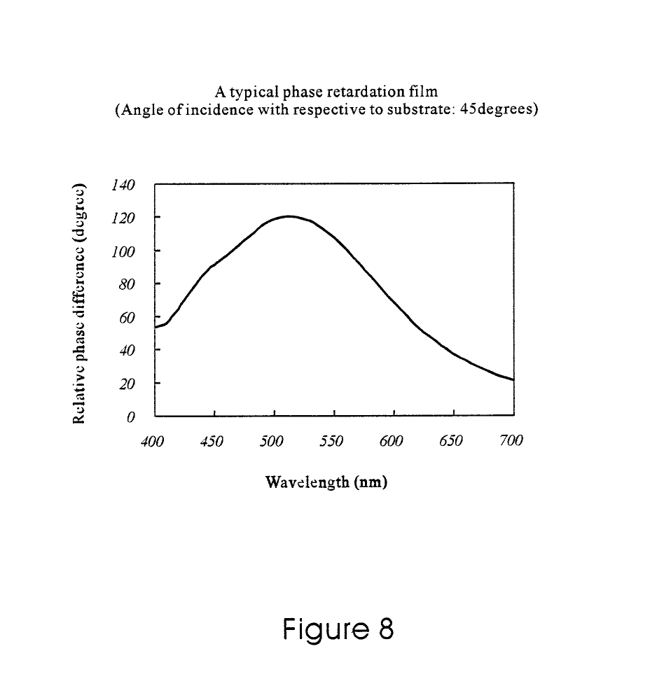

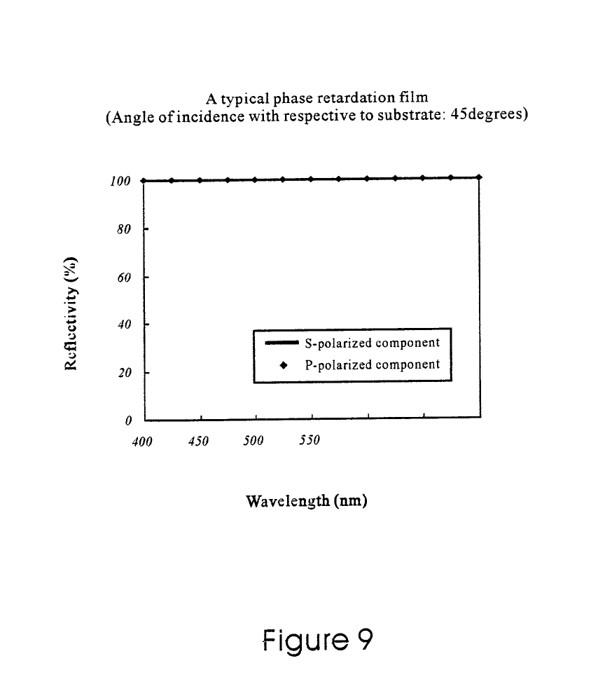

In consideration of the production process, the substrate 22 may be made of any suitable optical material, for example, plastic material such as PMMA, PC or ARTON™ or any other glass material, depending on the specific process therefor. In designing a suitable optical coating thereof, it is fundamental to determine the refractivity of the substrate in advance. Table 1 shows the refractivity over different wavelength for ARTON™ at different absorption rate and temperature. With reference to FIG. 8 and FIG. 9, the relative phase difference and the reflectivity of P-S polarized components over different wavelength of light beams reflected by a typical phase retardation film of high reflectivity are shown respectively.

It may be noted that in practical production, the phase retardation film is a dry film formed by an optical-precision application process or be coated through evaporation onto the ridged lower surface of the under plate so as to reflect the light beams incident thereto back to the substrate. For example, if the substrate is made of PMMA having optical coefficient 1.53 with the criteria that the ridge angle of the ridged lower surface of the under plate is 90 degrees and the wavelength of the incident light beam is 400 to 700 nm, the typical composition of the film may be MgF₂, ZnS, CeF₃, MgF₂, ZnS, CeF₃ and MgF₂, and the thickness thereof may be respectively 110.82, 20.13, 84.88, 141.93, 111.47, 84.88 and 25.38 nm. If the above conditions remain the same except for a substrate made of Norbornene (ARTON™), the composition of the film may be MgF₂, ZnS, CeF₃, MgF₂, ZnS, CeF₃ and MgF₂, and the thickness thereof may be respectively 110.14, 26.54, 84.88, 139.92, 117.22, 84.88 and 117.71 nm.

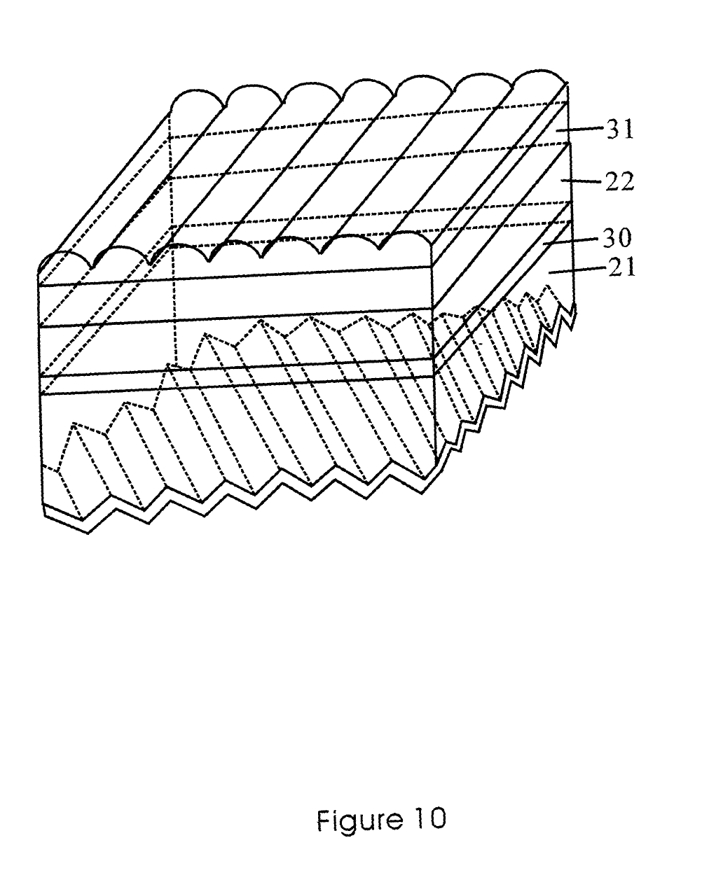

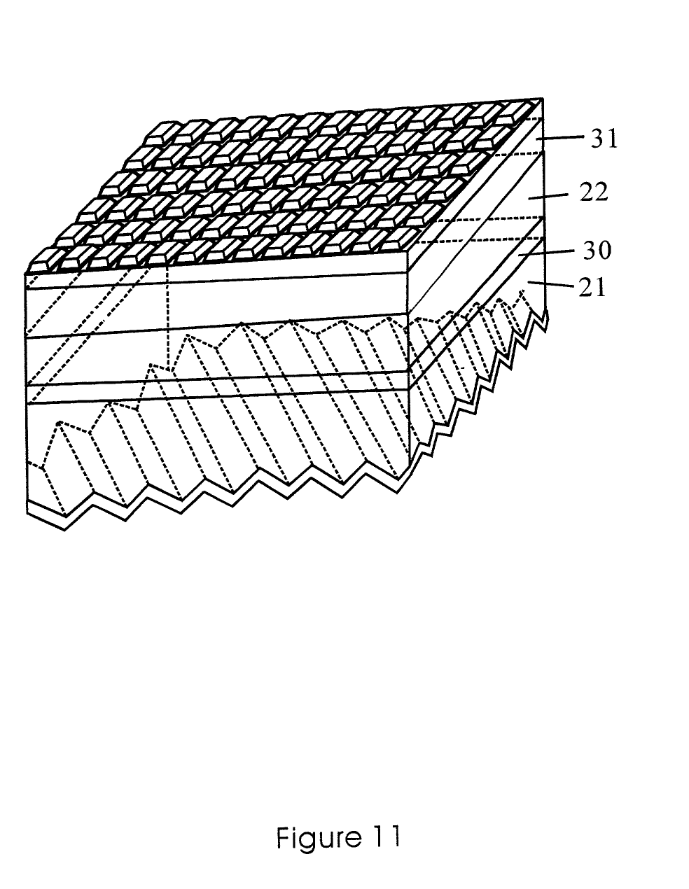

For increasing the transmissivity of the light beams, films having undulations of any suitable profiles can be disposed on the polarization splitting film 31 such that the output light beam can be in parallel or at any suitable angle. FIG. 10 shows that a film having cylindrical undulations thereon is disposed on the polarization splitting film. FIG. 11 shows a film having square protuberances thereon is disposed on the polarization splitting film. In this way, the output angle as well as the diffusion angle of the polarized light beams may be controlled and determined, and thus the output illuminance over different angles of view may be predetermined.

For further increasing the efficiency of the output of the polarized light beams, reflective films can be applied on the four side-surfaces of the substrate 22 so as to confine the light beams reflected therein from emitting therethrough. Accordingly, the optical loss of the backlight module may be further decreased. The reflective films can be coated through evaporation, and the composition and the thickness thereof respectively can be looked up from Table 2.

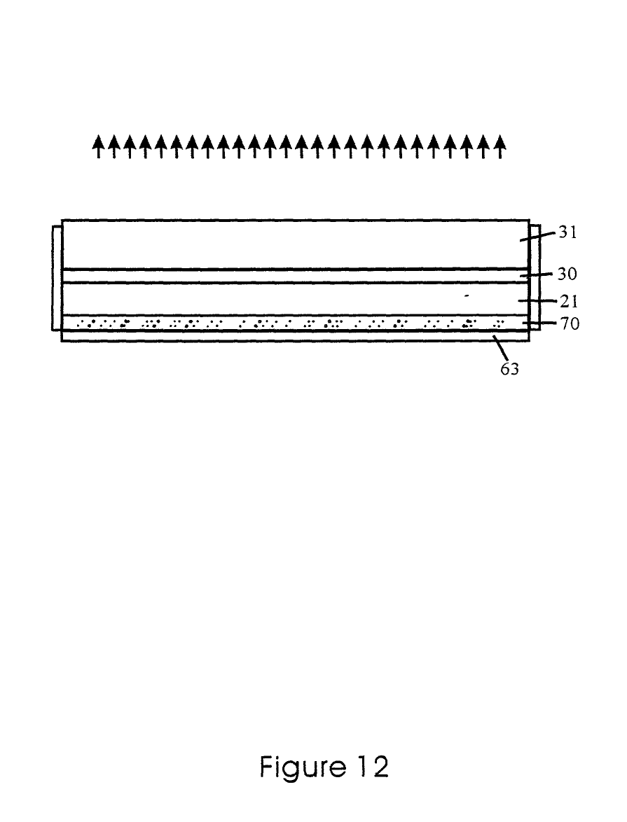

With reference to FIG. 12, a backlight module according to another embodiment of the present invention is shown, wherein the lower surface of the under plate 21 is of unspecific profile and a scattering structure 70 is provided thereon. A reflective film of high reflectivity 63 is provided on the lower surface of the scattering structure 70. Thus, the conversion of the polarization states of light beams according to the previous embodiments of the present invention may be achieved based on the scattering effect by the scattering structure 70. It should be noted that the scattering structure may be formed by a painting process or formed of materials of different optical coefficients. Moreover, the scattering effect by the scattering structure can be achieved through the rough surface thereof. In addition, for constructing another complete backlight module based on above embodiment, the scattering structure 70 can be directly attached onto the double-sided electroluminescent panel 30 with the under plate 21 being omitted.

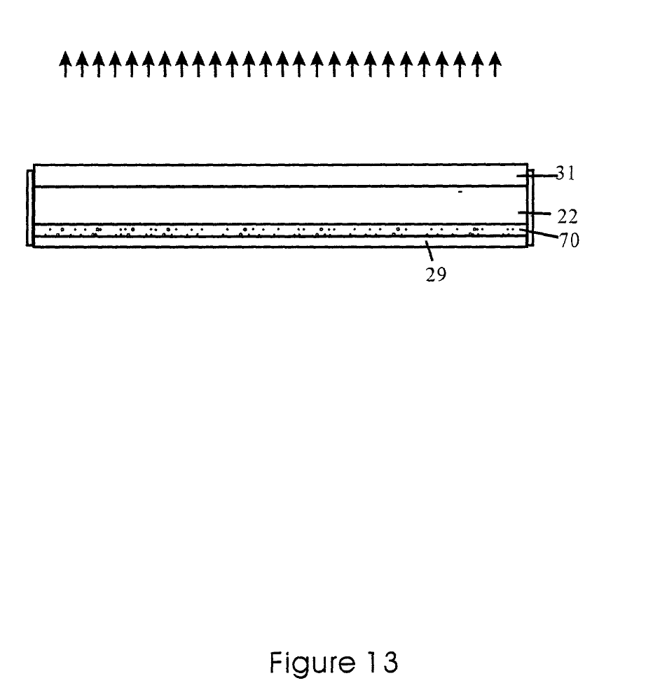

With reference to FIG. 13, a backlight module utilizing a single-sided electroluminescent panel according to another embodiment of the present invention is shown. In this case, a scattering structure 70 is disposed between the upper surface of the single-sided electroluminescent panel 29 and the substrate 22, with the under plate being omitted. Similarly, the conversion of the polarization states of light beams may be achieved based on the scattering effect by the scattering structure 70. In addition, the substrate 22 can be further omitted to simplify the construction of the backlight module.

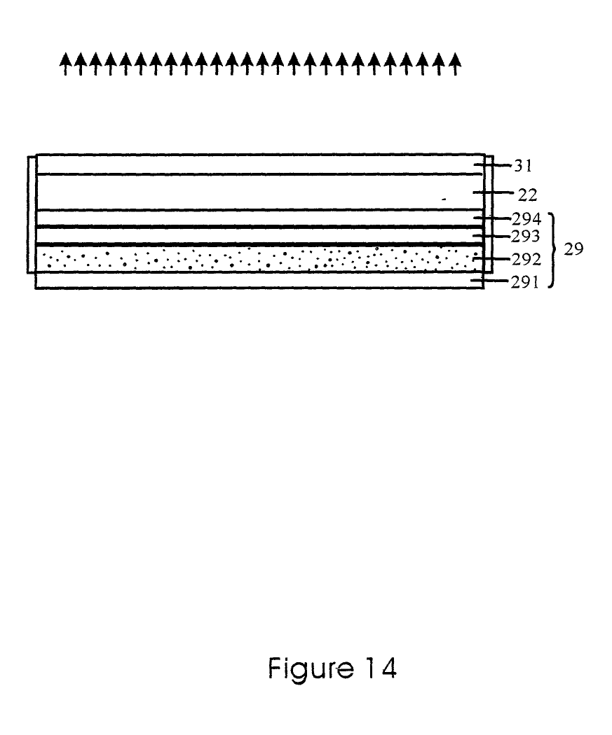

With reference FIG. 14, another backlight module utilizing a single-sided electroluminescent panel according to another embodiment of the present invention is shown, wherein the insulating layer of the single-sided electroluminescent panel 29 has a high scattering coefficient. Since the conversion of the polarization states of light beams can be achieved by the insulating layer of the single-sided electroluminescent panel 29, neither a under plate nor a scattering structure is necessary in this embodiment. In addition, attaching the polarization splitting film 31 with the single-sided electroluminescent panel 29 directly with the substrate 22 being further omitted can simplify the construction of the backlight module.

Although the preferred embodiment of the present invention have been disclosed for illustrative purposes, those skilled in the art will appreciate that various modification, additions and substitutions are possible, without departing from the scope and spirit of the present invention as recited in the accompanying claims.

TABLE 1
ARTON FX26
Main Chain: NORBORNENE
Branch Chain: polyester function group

| | Measured wavelength | | | | |
|---|---|---|---|---|---|
| | 794.76 nm | 656 nm | 588 nm | 486 nm | 436 nm |
| Absorption | | | | | |
| rate(%) | | | | | |
| 0.01 | 1.5161 | 1.5198 | 1.5227 | 1.5298 | 1.5354 |
| 0.25 | 1.5163 | 1.5200 | 1.5230 | 1.5300 | 1.5357 |
| temperature | | | | | |
| (° C.) | | | | | |
| 30 | 1.515 | 1.519 | 1.521 | 1.528 | 1.534 |
| 40 | 1.514 | 1.518 | 1.520 | 1.527 | 1.533 |

TABLE 2
Typical composition and thickness of anti-reflection layer
(unit: nm)

ZnS 38.59 [symbol] MgF₂ 66.30 [symbol] ZnS 41.01 [symbol] MgF₂ 70.47 [symbol] ZnS
43.59 [symbol] MgF₂ 74.89 [symbol] ZnS 46.33 [symbol] MgF₂ 79.60 [symbol] ZnS 49.24 [symbol]
MgF₂ 84.60 [symbol] ZnS 52.33 [symbol] MgF₂ 89.91 [symbol] ZnS 55.62 [symbol] MgF₂
95.56 [symbol] ZnS 59.11 [symbol] MgF₂ 101.56 [symbol] ZnS 62.83 [symbol] MgF₂ 107.93 [symbol]
ZnS 66.77 [symbol] MgF₂ 114.73 [symbol] ZnS 70.96 [symbol] MgF₂ 121.92 [symbol] ZnS
75.41 [symbol] MgF₂ 129.58 [symbol] ZnS 80.15 [symbol] MgF₂ 137.72 [symbol] ZnS 85.18 [symbol]
MgF₂ 146.38 [symbol] ZnS 90.54 [symbol] MgF₂ 155.56 [symbol] ZnS 96.23 [symbol] MgF₂
165.34 [symbol] ZnS 102.27 [symbol] MgF₂ 175.72 [symbol] ZnS 108.70

What is claimed is:

1. A backlight module for generating a light source of single polarization state, comprising:
an under plate having a ridged lower surface and an upper surface;
a phase retardation film of high reflectivity, disposed on the ridged lower surface of the under plate;
a double-sided electroluminescent panel having a lower surface, substantially complementary to the upper surface of the under plate and facing therewith, and an upper surface;
a substrate having a lower surface, substantially complementary to the upper surface of the double-sided electroluminescent panel and facing therewith, an upper surface and four side surfaces; and
a polarization splitting film disposed on the upper surface of the substrate, providing transmission of predetermined polarization state and reflection of predetermined polarization state of the light source.

2. The backlight module according to claim 1, wherein the double-sided electroluminescent panel comprises an illuminating layer, an insulating layer and two transparent electrodes.

3. The backlight module according to claim 1, further comprising an undulated film disposed on the polarization splitting film for controlling the output angle and diffusion angle of the light beams.

4. The backlight module according to claim 1, wherein the polarization splitting film is a 408-layer multilayer film composed of PEN and coPEN.

5. The backlight module according to claim 1, wherein the polarization splitting film is a 204-layer multilayer film composed of PEN and coPEN.

6. The backlight module according to claim 1, wherein the polarization splitting film is a 601-layer multilayer film composed of PET and Ecdel.

7. The backlight module according to claim 1, wherein the polarization splitting film is a 449-layer multilayer film composed of PEN and coPEN.

8. The backlight module according to claim 1, wherein the polarization splitting film is a 601-layer multilayer film composed of PEN and coPEN.

9. The backlight module according to claim 1, wherein the polarization splitting film is a 449-layer multilayer film composed of PET and coPEN.

10. The backlight module according to claim 1, wherein the polarization splitting film is a 481-layer multilayer film composed of PEN and sPS.

11. The backlight module according to claim 1, wherein the polarization splitting film is a 601-layer anti-reflection multilayer film composed of PEN and coPEN.

12. The backlight module according to claim 1, wherein the phase retardation film is a dry film formed by an optical-precision application process.

13. The backlight module according to claim 1, further comprising reflective films disposed on four side-surfaces of the substrate.

14. A backlight module for generating a light source of single polarization state, comprising:
an under plate having a ridged lower surface and an upper surface;
a phase retardation film of high reflectivity, disposed on the ridged lower surface of the under plate;
a double-sided electroluminescent panel having a lower surface, substantially complementary to the upper surface of the under plate and facing therewith, and an upper surface; and
a polarization splitting film disposed on the upper surface of the double-sided electroluminescent panel, providing transmission of predetermined polarization state and reflection of predetermined polarization state of the light source.

15. A backlight module for generating a light source of single polarization state, comprising:
a double-sided electroluminescent panel having a lower surface and an upper surface;
a scattering structure having an upper surface, substantially complementary to the lower surface of the double-sided electroluminescent panel and facing therewith, and a lower surface;
a reflective film of high reflectivity disposed on the lower surface of the scattering structure; and
a polarization splitting film disposed on the upper surface of the double-sided electroluminescent panel, providing transmission of predetermined polarization state and reflection of predetermined polarization state of the light source.

16. The backlight module of claim 15, further comprising an under plate disposed between the double-sided electroluminescent panel and the scattering structure.

17. A backlight module for generating a light source of single polarization state, comprising:
a single-sided electroluminescent panel having an upper surface and a lower surface;
a scattering structure having a lower surface, substantially complementary to an upper surface of the single-sided electroluminescent panel and facing therewith, and an upper surface; and
a polarization splitting film disposed on the upper surface of the scattering structure, providing transmission of predetermined polarization state and reflection of predetermined polarization state of the light source.

18. The backlight module of claim 17, wherein the single-sided electroluminescent panel comprises an illuminating layer, an insulating layer, a transparent electrode and a reflective layer.

19. The backlight module of claim 17, further comprising a substrate disposed between the scattering structure and the polarization splitting film.

20. A backlight module for generating a light source of single polarization state, comprising:
a single-sided electroluminescent panel comprising an illuminating layer, an insulating layer of high scattering coefficient, a transparent electrode and a reflective layer; and
a polarization splitting film disposed on the single-sided electroluminescent panel, providing transmission of predetermined polarization state and reflection of predetermined polarization state of the light source.
